(19) United States
(12) Patent Application Publication
(10) Pub. No.: US 2026/0064439 A1
(43) Pub. Date: Mar. 5, 2026

(54) METHOD AND SYSTEM FOR CONFIGURING A USER INTERFACE (UI) FOR A USER OF A BUILDING MANAGEMENT SYSTEM

(71) Applicant: Siemens Industry, Inc., Alpharetta, GA (US)

(72) Inventor: Qi LI, Chicago, IL (US)

(73) Assignee: Siemens Industry, Inc., Alpharetta, GA (US)

(21) Appl. No.: 18/819,289

(22) Filed: Aug. 29, 2024

(51) Int. Cl. G06F 9/451; G06Q 50/163

(52) U.S. Cl. CPC G06F 9/451; G06Q 50/163

(57) ABSTRACT

A method for displaying a user interface (UI) includes providing time series data generated by devices of a building management system (BMS). The time series data represents different types of data generated by the devices. A first dataset that identifies at least one location is received. A second dataset that identifies at least one piece of equipment operated at the at least one location and controlled by the BMS is received. A third dataset that identifies a respective piece of equipment that uses each of the different types of data generated by the devices is received. A request for a portion of the time series data is received, the portion of the time series data is identified based on the received first dataset, the received second dataset, and the received third dataset, and the UI and the portion of the time series data are displayed.

### BACKGROUND

A building management system (BMS) controls a number of components (e.g., controllers and sensors) for heating, ventilation, and cooling (HVAC), electrical metering, safety, and/or other operations. These components are interconnected and controlled. The controllers and sensors, for example, generate a large amount of data (e.g., time series data) about operation of the different components. Where multiple buildings are involved, even more data is generated.

BMS workstations and remote applications that are integrated with such BMS workstations may have user interfaces (Uls) (e.g., BMS interfaces) that require manual configuration to customize the UI for a particular facility or building. Such manual configuration of the UI may be performed by a technician or an engineer based on preferences of an owner of the facility or building for data points to be monitored or controlled in the facility or building.

### SUMMARY

Employees of an enterprise that operates at the facility or building may not be consulted as to configuration of such BMS interfaces. Accordingly, conventional BMS interfaces may not be suited for or customized to employees of the enterprise, such as, for example, doctors or nurses at a hospital.

In order to provide a custom view of building data for a user, a processor receives a plurality of linked datasets that link locations within one or more buildings controlled by a building management system and equipment operated within the one or more buildings, with different types of data generated by devices of the building management system. The plurality of linked datasets include a first dataset that identifies at least one location for the enterprise, a second dataset that identifies at least one piece of equipment operated at the at least one location, respectively, and controlled by the building management system, and a third dataset that identifies at least one type of data generated by the devices that is used by the at least one piece of equipment, respectively.

The user may be associated with locations for the enterprise (e.g., based on a role of the user within the enterprise; a nurse may be associated with rooms overseen by a particular nurse station within a hospital). The user submits identification information (e.g., a username and/or a password) at a computing device of the building management system, and the device transmits the identification information to a server (e.g., a cloud server). The server identifies a portion of time series data generated by the building management system and UI templates to be displayed at the device of the building management system based on the identification information and the plurality of linked datasets. A grouping of locations managed by the building management system that is associated with a particular employee role at an enterprise is used to select UI templates and corresponding data. The server transmits the portion of the time series data and the UI templates to the device, and a display of the computing device displays the UI templates with the portion of the time series data. As a result, the UI displayed to the user is appropriate for that user, even where the user is not a building engineer or building technician. Rather than a UI customized to someone responsible for operation of the building automation for a building, the UI is customized to the person fulfilling a function of the enterprise at a location in the building.

In a first aspect, a method for displaying a user interface (UI) with information related to equipment within one or more buildings of an enterprise includes providing time series data generated by devices of a building management system. The time series data represents different types of data generated by the devices, respectively. The method includes identifying a first dataset. The first dataset identifies at least one location for the enterprise. The method includes identifying a second dataset. The second dataset identifies at least one piece of equipment operated at the at least one location, respectively, and controlled by the building management system. The method includes identifying a third dataset. The third dataset identifies at least one type of data of the different types of data used by the at least one piece of equipment, respectively. The first dataset, the second dataset, and the third dataset are linked. The method includes receiving a request for a portion of the time series data. The portion of the time series data corresponds to a location of the at least one location identified within the first dataset. The method includes identifying, by a processor, the portion of the time series data based on the received request, the received first dataset, the received second dataset, and the received third dataset. The identifying of the portion of the time series data includes traversing, by the processor, the linked first dataset, the second dataset, and the third dataset based on the location, such that a piece of equipment of the at least one piece of equipment of the second dataset and a type of data of the different types of data of the third dataset are identified. The method includes generating and displaying the UI, which is configured using the portion of the time series data. The portion of the time series data includes the identified type of data for the identified piece of equipment.

In a second aspect, a system for displaying a user interface (UI) with information related to equipment within one or more buildings of an enterprise to a user of a building management system is provided. The user has a role specific to a function of the enterprise. The system includes a database that includes a plurality of UI templates. Each UI template of the plurality of UI templates is linked to at least one type of data. The database also includes a plurality of datapoints generated by the building management system. Each datapoint of the plurality of datapoints generated by the building management system corresponds to a respective one of the types of data and is linked to at least one UI template of the plurality of UI templates. The system also includes a processor in communication with the database. The processor is configured to identify a first dataset. The first dataset identifies at least one location for the enterprise. The processor is also configured to identify a second dataset. The second dataset identifies at least one piece of equipment operated at the at least one location, respectively, and controlled by the building management system. The processor is also configured to identify a third dataset. The third dataset identifies at least one type of data of the different types of data used by the at least one piece of equipment, respectively. The first dataset, the second dataset, and the third dataset are linked. The processor is further configured to receive a request for a portion of the time series data, identify a subset of datapoints of the plurality of datapoints based on the received request, the received first dataset, the received second dataset, and the received third dataset, and identify a subset of UI templates of the plurality of UI templates based on the identified subset of datapoints. The system also includes a display in communication with the processor. The display is configured to display the identified subset of datapoints within the subset of UI templates as the UI.

In a third aspect, a method for displaying a user interface (UI) to display information related to equipment within one or more buildings of an enterprise includes providing time series data generated by devices of a building management system. The time series data represents different types of data generated by the devices, respectively. The method includes receiving a first dataset. The first dataset identifies at least one location for the enterprise. The method includes receiving a second dataset. The second dataset identifies at least one piece of equipment operated at the at least one location, respectively, and controlled by the building management system. The method includes receiving a third dataset. The third dataset identifies at least one type of data of the different types of data used by the at least one piece of equipment, respectively. The first dataset, the second dataset, and the third dataset are linked. The method includes receiving, by a computing device of the building management system, identification data for a user of the computing device, transmitting the identification data for the user to a cloud server, and identifying a number of the different types of data based on transmitted identification data, the received first dataset, the received second dataset, and the received third dataset. The method includes identifying a portion of the time series data based on the identified number of different types of data, and identifying a subset of UI templates from a plurality of UI templates stored at a memory of the cloud server based on the identified number of types of data. The method includes transmitting the identified subset of UI templates and the identified portion of the time series data to the computing device of the building management system, and displaying the identified portion of the time series data within the subset of UI templates as the UI at a display of the computing device of the building management system.

Any one or more of the aspects or concepts summarized above or in the Illustrative Embodiments below may be used alone or in combination. The aspects or concepts described for one Illustrative Embodiment or aspect may be used in other embodiments or aspects. The aspects or concepts described for a method or system may be used in others of a system, method, or non-transitory computer readable storage medium.

These and other aspects, features, embodiments, and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The examples of the invention described below can be better understood with reference to the following figures. The components in the figures are not necessarily to scale, emphasis instead being placed upon illustrating the principles of the invention. In the figures, like reference numerals designate corresponding parts throughout the different views.

FIG. 1 shows one embodiment of a system for automatically configuring a user interface (UI) for a user of a building management system;

FIG. 2 shows one embodiment of a computer system for use with the system of FIG. 1;

FIG. 3 shows a flowchart of one embodiment of a method for automatically configuring a UI for a user of a building management system; and

FIG. 4 shows an example of a graphical user interface (GUI) configured for a user.

### DETAILED DESCRIPTION

There are known approaches for obtaining data points associated with building devices monitored and controlled by a building management system. These known approaches, however, do not provide a custom view of building data for a user as an employee of a building tenant (e.g., an enterprise). UI information for a user as a tenant instead of a building engineer or technician is provided by and/or on the building automation management system. Access to the building automation is open to the daily users using a template system.

In the present embodiments, user interface framework with application programming interface (API) is provided to interface with one or more cloud management applications and building management system data (e.g., data points of building devices currently monitored/controlled) associated with one or more buildings and tenants of (e.g., the enterprise at) the one or more buildings. As part of the commissioning process for a building, system architecture relevant to implementation of a building interface framework service is generated for a customer subscribing to the service.

Onboarding logic (e.g., a building management platform) for the subscribing customer provides the customer with the option to subscribe to various services (e.g., provided by the one or more cloud management applications). After subscribing, the onboarding logic sets up an account and a partition for the customer. A database of the building management system stores the building management system data, and the building management system data is pushed to or connected to the building management platform (e.g., the onboarding logic).

An experience manager application may be a cloud management application of the one or more cloud management applications. The experience manager application displays an onboarding webpage to an employee of the enterprise (e.g., an engineering technician). The engineering technician at the enterprise, for example, uploads an input file to the experience manager application. The input file is used to process the building management system data and identify relevant data points associated with the customer (e.g., the enterprise) and/or a particular user at the customer (e.g., an employee of the enterprise).

The input file includes, for example, workbook spreadsheets that link locations within the one or more buildings (e.g., identified by data within a first sheet of the workbook spreadsheet) with controllers and/or devices within the one or more buildings that generate the building management system data, and with equipment within the one or more buildings (e.g., identified by data within a second sheet of the workbook spreadsheet) that use the building management system data. The workbook spreadsheets also link the controller and/or devices and the equipment with different data types (e.g., identified by data within a third sheet of the workbook spreadsheet). The workbook spreadsheets may be generated by the engineering technician at the enterprise, for example, one or more other employees of the enterprise, and/or one or more other users outside of the enterprise.

The engineering technician at the enterprise, for example, may also upload an artifact project file (e.g., a json file) with meta data. The artifact project file may be missing tags to identify a type of room (e.g., as being a janitor closet versus a nurses station). A semantic enhancement engine may process both the input file and the artifact project file.

The semantic enhancement engine may provide totals of expected equipment versus realized equipment, for example. The semantic enhancement engine provides a quality check score to determine if a quantity of data points and relationships checked or present matches the expected based on an identified vertical market.

The building management system is a control system configured to monitor and/or control controllers, devices, and/or equipment (e.g., mechanical, electrical, and/or electromechanical equipment) within the one or more buildings of the enterprise. The controllers, devices, and/or equipment of the one or more buildings generates data (e.g., temperature data, pressure data, fan speed data) and transmits the generated data to the building management system (e.g., a memory or database of the building management system). The building management system transmits the generated data to the database in the Cloud, for example, where the generated data is stored. The generated data stored at the database in the Cloud includes a plurality of datapoints representing measurements of the controllers and/or devices of the one or more buildings at different time points, respectively.

The building management system and/or a processor in the Cloud may process the generated data. For example, the building management system and/or the processor in the Cloud may semantically enhance or tag the generated data, such that generated data is associated with the types of data, respectively, and is linked to the plurality of UI templates, respectively.

A workstation of the one or more buildings (e.g., of the building management system) receives user identification data for a user of the workstation. For example, the workstation includes one or more input devices (e.g., a keyboard and/or a mouse), and the workstation receives the user identification data via user input at the one or more input devices of the workstation. Any number of different types of user identification data may be received at the workstation. For example, the user identification data may include a username and/or a password corresponding to the user.

The workstation may transmit the user identification data to a processor (e.g., a processor in the Cloud running an application of a building management platform or another enterprise application or software) via a network (e.g., a wireless network). The processor in the Cloud, for example, may identify a role associated with the user based on the user identification data

The user is a tenant working in the environment (e.g., room, hallway, floor, or building) controlled by the building automation system. The user as a tenant may be different than a building engineer or technician whose role is to monitor, arrange, program, and/or fix the building automation system for other tenants.

The processor in the Cloud may identify a subset of UI templates of a plurality of UI templates stored at the database of the Cloud, for example, based on the user identification data, the identified role, and/or the input file. For example, the identified role may be associated with a location group defined within the input file, and the processor of the Cloud may determine types of data associated with the location group based on the input file. The processor in the cloud may then determine the subset of UI templates that correspond to the determined types of data (e.g., UI templates that display the determined types of data, respectively).

The processor in the Cloud (e.g., the processor in the Cloud running the application of the building management platform) may transmit (e.g., via the wireless network) data for the identified subset of UI templates and the linked datapoints to the workstation of the building management system, and a display of the workstation may display a UI including the subset of UI templates and the linked datapoints.

The automatically generated user-specific UI of the present embodiments displays relevant data generated by a building management system to a user with a particular role within an enterprise without time-consuming customization of the UI by the user being necessary. For example, the present embodiments decrease time to commission or configure a building management system user interface for a user having a role that is not a technician or facility administrator.

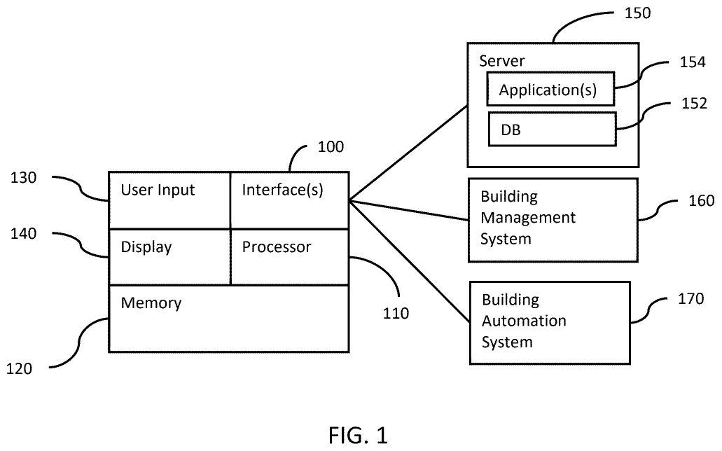

FIG. 1 shows a building control system. The building control system may form a building automation system or include a building automation system. The building control system controls a building automation system 170.

The building control system includes an interface or interfaces 100, a processor 110, a memory 120, a user input 130, and a display 140. The interface 100, the display 140, the processor 110, the user input 130, and/or the memory 120 may be part of a computer, a server, a workstation, or another system, such as the building automation system 170 or a building management system 160. In one embodiment, the building control system includes a plurality of workstations or computers within one or more buildings of an enterprise. Each workstation or computer of the plurality of workstations includes at least an interface or interfaces 100, a processor 110, a memory 120, a user input 130, and a display 140. For example, a nurse or doctor has access to a computer, which is used for various purposes. The computer may provide access to the building control system, such as the processor 110 being the processor of the computer.

The building control system may further include a server 150 connected to the interfaces 100 through a computer network. The server 150 hosts a database 152 and one or more applications 154 (e.g., including Internet of things (loT) applications). In other embodiments, the database 152 is hosted locally to the processor 110, such as where the processor 110 is part of a server or where the database 152 is implemented on a computer of a manager of the building automation system 170. In other implementations, the processor 110 is part of the building automation system 170, whether local or remote from the building. In yet another implementation, the processor 110 is part of the building management system 160, whether local or remote from the building.

Users (e.g., workers at an enterprise) may use the plurality of workstations to receive and/or generate data and transmit the data to the server 150. Each workstation of the plurality of workstations and the server 150 may be located in the same or different rooms, the same or different facilities, or the same or different enterprise campuses. The plurality of workstations may be operated in one or more first geographic locations, and the server 150 may be operated in a second geographic location that is remote from the first geographic location.

The building control system may include more databases 152 within the server 150 or separate from the server 150. The database 152 includes a plurality of datasets. Each dataset of the plurality of datasets may include, for example, datapoints generated by the building management system 160, source code, a computer program representing an application, a set of subroutine definitions, communication protocols, tools representing an API, a data model, one or more computer system configurations, or any combination thereof.

Additional, different, or fewer components may be provided. For example, a computer network is included for use of the applications 154 based on locally entered input and output results. As another example, additional building automation systems 170 are provided, such as where the processor 110 and/or server 150 are used for a service provided to different building automation systems or a building automation system for multiple buildings. In another example, the building automation system 170, the building management system 160, and/or the server 150 are not provided.

The building automation system 170 includes heating ventilation air conditioning (HVAC)) fire safety, security, and/or other automated components for operating one or more buildings of an enterprise. The building automation system 170 may be for one building, one floor, multiple floors of a building, multiple buildings, a facility, and/or a complex. The building automation system 170 may include panels, controllers, sensors, user inputs, actuators, alarms, ducts, heaters, fans, air conditioners, filters, boilers, heat exchangers, supervisor computers, and/or other components. The components are communicatively connected so that the building automation system 170 may be monitored, altered, and/or otherwise controlled.

The building management system 160 may be a computer that is part of or separate from the building automation system 170. The building management system 160 may be implemented on a panel or another processor, whether remote or local to the building automation system 170. The building management system 160 communicates over a computer network with the components of the building automation system 160, such as communicating with panels of the building automation system 160. The building management system 160 may receive time series data indicating the operation of the various components of the building automation system 170. In one embodiment, the building management system 160 may forward the received time series data indicating the operation of the various components of the building automation system 170 to the server 150 (e.g., the database 152 of the server 150). Other information, such as user interface (UI) templates, tickets, or user comments, may be provided to or stored at the building management system 160.

The building management system 160 executes a program for controlling the building automation system 170. A user interface (UI) for reviewing operation and data from the building automation system 170 and/or for changing operation of components of the building automation system 170 may be provided. The UI for reviewing operation and data from the building automation system 170 and/or for changing operation of components of the building automation system 170 may be displayed at the display 140 of the building control system. In one implementation, the processor 110 is part of the building management system 160.

The building management system 160 is configured by program code to generate a list of faults in operation of the building automation system 170 and to generate statistics for the operation of the building automation system 170. In alternative implementations, the statistics are created by another computer, so the building management system 160 generates the statistics by receipt and adding to a prompt.

The interface 100 is shown as one interface, but multiple interfaces may be provided. The interface 100 is a modem, a computer network interface, an ethernet interface, Wi-Fi, Bluetooth, and/or other computer networking interface for receiving and/or transmitting communications.

The interface 100 is configured by a specification or standard design, controller, and/or by the processor 110. The interface 100 is configured to receive information from the building automation system 170, the building management system 160, and/or the server 150. The interface 100 is also configured to transmit information from the building automation system 170 and/or the building management system 160 to the server 150.

The processor 110 is a control processor, a general processor, a digital signal processor, a graphics processing unit, an application specific integrated circuit, a field programmable gate array, an artificial intelligence processor or accelerator, a digital circuit, an analog circuit, combinations thereof, or another now known or later developed device for, for example, generating a UI. The processor 110 is part of the server 150, the building management system 160, the building automaton system 170, or a stand-alone computer, server, or workstation. The processor 110 is a single device, a plurality of devices, or a network. For more than one device, parallel or sequential division of processing may be used. Different devices making up the processor 110 may perform different functions or the same function in parallel. The processor 110 operates pursuant to stored instructions, hardware, and/or firmware to perform various acts described herein.

The memory 120 is configured by formatting and/or the processor 110 to store information for monitoring the building automation system 170. For example, the memory 120 stores a plurality of UI templates.

The memory 120 is an external storage device, RAM, ROM, database, and/or a local memory (e.g., solid state drive or hard drive). The same or different non-transitory computer readable media may be used for the instructions and other data. The memory 120 may store instructions for operating the processor 110 and/or the server 150. The memory 120 may be implemented using a database management system (DBMS) and/or be a hard disk, RAM, or removable media. Alternatively, the memory 120 is internal to the processor 110 (e.g., cache). The memory 120 is formed from one device or a collection of devices, such as different memories storing different types of data.

Instructions for generating an input file (e.g., formed by a workbook spreadsheet including a plurality of sheets or datasets), identifying types of data to be displayed based on the input file, generating UI templates, identifying a role associated with a user, identifying a subset of the UI templates, and displaying the identified subset of UI templates by the processor 110 are provided on non-transitory computer-readable storage media or memories, such as a cache, buffer, RAM, removable media, hard drive or other computer readable storage media (e.g., the memory 120). Computer readable storage media include various types of volatile and nonvolatile storage media. The functions, acts, or tasks illustrated in the figures or described herein are executed in response to one or more sets of instructions stored in or on computer readable storage media. The functions, acts or tasks are independent of the particular type of instructions set, storage media, processor, or processing strategy and may be performed by software, hardware, integrated circuits, firmware, micro code, and the like, operating alone or in combination.

In one embodiment, the instructions are stored on a removable media device for reading by local or remote systems. In other embodiments, the instructions are stored in a remote location for transfer through a computer network. In yet other embodiments, the instructions are stored within a given computer, CPU, GPU, or system. Because some of the constituent system components and method steps depicted in the accompanying figures may be implemented in software, the actual connections between the system components (or the process steps) may differ depending upon the way the present embodiments are programmed.

The server 150 is a computer, workstation, graphics processing unit, tensor processor, artificial intelligence processor, and/or server card. The server 150 is configured by hardware, firmware, and/or software to implement one or more applications stored at the server 150. Alternatively, the processor 110 implements the one or more applications.

The user input 130 is a keyboard, buttons, sliders, dials, trackball, mouse, touch pad, touch screen, microphone, and/or another device for user interaction with the processor 110 and/or building control system. The user input 130 is part of a graphics user interface for receiving user input, such as setpoint control. The user input 130 may be configured by the processor 110 and/or hardware to receive inputs for interaction of the user with applications stored at the server 150.

The display 140 is a CRT, LCD, projector, plasma, printer, tablet, smart phone, or another now known or later developed display device for displaying the UI, monitored data, and/or other information. The display 140 is configured by loading an image to a display buffer or plane, and the image is then displayed on a screen. Other configuration may be provided, such as configuring for display by printing.

In other implementations, the building control system includes multiple building automation systems 170, or the building automation system 170 is for multiple buildings. The building management system 160 connects with the multiple buildings or building automation systems 170. The processor 110 is a server, workstation, or computer configured to generate and display Uls for multiple users of the server, workstation, or computer.

An employee of an enterprise for which the building management system 160 is operated and/or one or more users outside of the enterprise may generate an input file that models the enterprise and links data types for time series data generated by the building management system 160 to devices and controllers (e.g., devices) that generate data within the building management system 160 and equipment that uses the generated data within the building management system 160. The input file also links the devices and the equipment of the building management system 160 to locations (e.g., location groups, buildings, rooms, and floors) managed by the building management system 160.

In one embodiment, the input file is a workbook spreadsheet that includes a plurality of sheets. Each sheet of the plurality of sheets forms a dataset of a plurality of datasets. The plurality of datasets model the enterprise and are linked to each other. In one embodiment, the processor of the Cloud (e.g., corresponding to the server 150) receives the plurality of datasets based on user input at a computing device outside of the building control system. In another embodiment, alternatively or additionally, the processor 110 of the building control system receives at least some data of the plurality of datasets based on user input at the building control system, and the building control system transmits such data to the processor of the Cloud. In other words, the input file may be generated by one or more employees at the enterprise (e.g., at computing devices of the building control system) and/or one or more people outside of the enterprise (e.g., an engineering technician acting on behalf of the enterprise or customer).

For example, an employee of the enterprise defines data (e.g., within cells) of a first dataset of the plurality of datasets (e.g., a first sheet of the plurality of sheets) using one or more input devices (e.g., a mouse and a keyboard) at a computing device of the building control system. The first dataset defines locations within the enterprise controlled by the building control system. As shown in the example below in Table 1, the first dataset may define buildings, floors, and rooms operated by the customer (e.g., the enterprise) and/or controlled by the building control system.

TABLE 1

| Building | Floor | Room | UsageType | LocationGroupName | LocationDesignator |
|---|---|---|---|---|---|
| North Tower | | | | | Building: North Tower |
| South Tower | | | | | Building: South Tower |
| Pavillon Center | | | | | Building: Pavillon Center |
| North Tower | 0 | 01 | btlo: TreatmentRoom | 2477 Nurse Station | Building: North Tower_Floor: 0_Room: 01_RoomType: |
| | | | | | TreatmentRoom |
| North Tower | 1 | 100 | btlo: Kitchen | 2477 Pharmacy | Building: North Tower_Floor: 1_Room: 100_RoomType: Kitchen |
| North Tower | 2 | 200 | btlo: Laboratory | 2450 Nurse Station | Building: North Tower_Floor: 2_Room: 200_RoomType: |
| | | | | | Laboratory |
| North Tower | 3 | 300 | btlo: WaitingRoom | 2450 Nurse Station | Building: North Tower_Floor: 3_Room: 300_RoomType: |
| | | | | | WaitingRoom |
| North Tower | 4 | 400 | selo: CathLab | 2477 Pharmacy | Building: North Tower_Floor: 4_Room: 400_RoomType: CathLab |
| North Tower | 5 | 500 | selo: AutopsyRoom | 2477 Surgeon | Building: North Tower_Floor: 5_Room: 500_RoomType: |
| | | | | | AutopsyRoom |
| North Tower | 5 | 501 | btlo: Toilet | 2477 Pharmacy | Building: North Tower_Floor: 5_Room: 501_RoomType: Toilet |
| South Tower | 1 | 101 | btlo: Hallway | 2450 Nurse Station | Building: South Tower_Floor: 1_Room: 101_RoomType: Hallway |

In the example shown, the enterprise includes, and the first dataset defines, a “North Tower,” a “South Tower,” and a “Pavilion Center.” In such an example, the enterprise occupies and/or the building control system controls devices, controllers, and/or equipment within buildings named the “North Tower,” the “South Tower,” and the “Pavilion Center.” Additional, fewer, and/or different buildings may be defined by the employee, for example, within the first dataset.

The first dataset may define at least one separate location (e.g., within at least one separate row within the first sheet) for each floor of a respective building of the enterprise (e.g., for each of the buildings that has more than one floor occupied by the enterprise). For example, referring to the example of Table 1, rows four through ten define locations at floors 0-5 of the “North Tower” building. Additional, fewer, and/or different floors may be defined by the employee, for example, within the first dataset.

The first dataset may also define at least one separate location (e.g., at least one separate row within the first sheet) for each room of a respective floor (e.g., for each of the floors that has more than one room occupied by the enterprise). For example, referring to the example of Table 1, rows nine and ten define room 500 and room 501, respectively, of floor 5 of the “North Tower” building. Additional, fewer, and/or different rooms may be defined by the employee, for example, within the first dataset.

The first dataset may define more, less, and/or different data. For example, for each room defined within the first dataset, the first dataset may also define a usage type for the respective room. The employee, for example, may select a usage type for the respective room from a predetermined set of usage types. For example, for an enterprise that is a hospital, the predetermined set of usage types may include hallway, kitchen, laboratory, meeting room, toilet, treatment room, waiting room, ante room, autopsy room, catheterization lab, clean storage, CT room, and/or other usage types.

Additional, fewer, and/or different usage types may be defined for different enterprises. For example, for an enterprise that is a school, the predetermined set of usage types may include classroom, office, gymnasium, and amphitheater.

As another example, as will be discussed in more detail below, the first dataset may define, for at least some locations defined by the first dataset (e.g., at least some subsets, or rows, of the first dataset that include data for a floor), a location group to which the respective location belongs.

A processor (e.g., the processor 110 of the building control system) generates location designators for at least some locations defined within the first dataset (e.g., locations that include a floor) based on data within each subset of the first dataset (e.g., each row of the first sheet or dataset). For example, the processor may generate a location designator that includes data identifying the particular building, the particular floor, the particular room, and the usage type. For example, referring to the example of Table 1, the processor may generate a location designator for room 200 (e.g., corresponding to row six) of “Building:North Tower_Floor:2_Room:200_RoomType:Laboratory.” The processor may generate location designators in different ways including different information.

The employee of the enterprise, for example, also defines data (e.g., within cells) of a second dataset of the plurality of datasets (e.g., a second sheet of the plurality of sheets) using one or more input devices (e.g., the mouse and the keyboard) at the computing device of the building control system, for example. The second dataset defines equipment within the locations defined by the first dataset, controlled by the building control system. As shown in the example below in Table 2, the second dataset may define, for each piece of equipment controlled by the building control system, an equipment type, an instance number of the equipment type within a particular location, and a location of the respective piece of equipment.

TABLE 2

| Equip [symbol] | EquipmentType | Instance | ControlledByDevice | Con [symbol] Location | EquipmentDesignator |
|---|---|---|---|---|---|
| 92 [symbol] | [symbol] | | Device [symbol] | Building: North Tower_Floor: 2_RoomType: | Device: MY_AC1_ [symbol] _Equipment: [symbol] |
| | | | | Laboratory | |
| [symbol] | [symbol] Moter | | Network [symbol] | Building: North Tower_Floor: 5_RoomType: | Network:_ [symbol] _Equipment: Floor [symbol] |
| | | | | AutopsyRoom | |
| 41 [symbol] | [symbol] Unit | | Device [symbol] | Building: North Tower_Floor: 3_RoomType: | Device: [symbol] _Equipment: [symbol] |
| | | | | WaitingRoom | |
| 512 [symbol] | [symbol] | 1 | Device [symbol] | Building: North Tower_Floor: [symbol] _RoomType: | Device: [symbol] _Equipment: |
| | | | | CathLab | ExhaustFan_Instance: 1 |
| [symbol] | [symbol] | 2 | Network [symbol] | Building: North Tower_Floor: [symbol] _RoomType: | Network:_Device: [symbol] _Equipment: |
| | | | | CathLab | ExhaustFan_Instance: 2 |

[symbol]

indicates data missing or illegible when filed

In the example shown, equipment identification numbers for each piece of equipment controlled by the building control system may be defined by the employee of the enterprise or may be imported from another source. For example, the equipment identification numbers may be maintained within another dataset (e.g., as the equipment is brought online within the locations defined by the first dataset), and the equipment identification numbers may be imported from the other dataset.

The second dataset may also define a type of equipment for each piece of equipment defined by the second dataset (e.g., within a respective row of the second sheet). The employee, for example, may select a type of equipment for the respective piece of equipment from a predetermined set of equipment types. For example, the predetermined set of equipment types may include air handling unit, constant volume box, exhaust fan, lab control unit, VAV box, dual duct CAV, dual duct VAV, fan powered box, fan coil unit, sensor, electric meter, flow meter, and/or other equipment types.

The second dataset may also define an equipment instance for a type of equipment at a particular location. For example, referring to the example of Table 2, row four and row five define a first instance and a second instance, respectively, of an exhaust fan within a same location (e.g., North Tower, floor 4, catheterization lab room).

The second dataset may also define locations in which the equipment is installed. The employee, for example, may select a location, as defined in the first dataset, for each piece of equipment defined by the second dataset. For example, the employee may select from the location designators generated by the processor and included in the first dataset. The second dataset may be linked to the first dataset via the selected location designators.

The second dataset may define more, less, and/or different data. For example, for each piece of equipment defined within the second dataset, the second dataset may also define a device that controls the respective piece of equipment. As discussed further below, the employee, for example, may select from device designators generated by the processor.

A processor (e.g., the processor 110 of the building control system) generates equipment designators for at least some equipment defined within the second dataset based on data within each subset of the second dataset (e.g., each row of the second sheet or dataset). For example, the processor may generate an equipment designator that includes data identifying the type of equipment, the equipment instance, and the device that controls the equipment. For example, referring to the example of Table 2, the processor may generate an equipment designator for instance 1 of the exhaust fan (e.g., corresponding to row four) of “Device:MY_A05_PXCM_Equipment:ExhaustFan_Instance:1.” The processor may generate location designators in different ways including different information.

The employee of the enterprise, for example, also defines data (e.g., within cells) of a third dataset of the plurality of datasets (e.g., a third sheet of the plurality of sheets) using one or more input devices (e.g., the mouse and the keyboard) at the computing device of the building control system, for example. The third dataset defines types of data points used by the equipment defined by the second dataset. As shown in the example below in Table 3, the third dataset may define, for each type of time series data (e.g., type of data) generated by the building control system (e.g., generated and/or hosted by devices of the building control system), a piece of equipment that uses the respective type of data and a kind of the respective type of data.

TABLE 3

| PointName | HostedOnDevice | UsedByEquipment | PointKind |
|---|---|---|---|
| MY_A01_OCC | Device: MY_A01_PXCM | Device: MY_A01_PXCM_Equipment: CVBox | Temperature |
| MY_A01_SAT | Device: MY_A01_PXCM | Network:_Device: MY_A04_PXCM_Equipment: FlowMeter | BuildingPressure |
| MY_A01_SAS | Device: MY_A01_PXCM | Device: MY_A04_PXCM_Equipment: FanCoilUnit | Humidity |
| MY_A01_RAT | Device: MY_A01_PXCM | Device: MY_A05_PXCM_Equipment: ExhaustFan_Instance: 1 | FanSpeed |
| MY_A01_SAF1 | Device: MY_A01_PXCM | Network:_Device: ED_A09_PXCM_Equipment: ExhaustFan_Instance: 2 | FanSpeed |

In the example shown, a point name for each type of time series data generated by the building control system may be defined by the employee of the enterprise or may be imported from another source. For example, the point names may be imported from the building control system.

The third dataset also defines equipment that uses the respective type of data. The employee, for example, may select a piece of equipment, as defined in the second dataset, for each type of data. For example, the employee may select from the equipment designators generated by the processor and included in the second dataset. The third dataset may be linked to the second dataset via the selected equipment designators.

The third dataset also defines a kind of data associated with the respective type of data. For example, the employee may select from predetermined point kind datasets that correspond to the equipment defined in the second dataset and included within the third dataset, respectively.

For example, for a constant volume box, the predetermined point kind dataset may include temperature set point, temperature, humidity set point, humidity, CO₂, occupancy, total ach, air quality index, heating setpoint, cooling setpoint, and/or other kinds of data. For an air handling unit, the predetermined point kind dataset may include supply fan status, supply fan speed, supply fan speed setpoint, return fan status, return fan speed, return fan speed setpoint, supply air temperature, supply air temperature setpoint, return air temperature, duct static pressure, duct state pressure setpoint, and/or other kinds of data. For an exhaust fan, the predetermined point kind dataset may include fan status, fan speed, fan speed setpoint, and/or other kinds of data. For a lab control unit, a VAV box, a dual duct CAV, a dual duct VAV, a fan powered box, a fan coil unit, and an electric meter, the predetermined point kind dataset may include temperature setpoint, temperature, humidity setpoint, humidity, CO₂, occupancy, total air changes per hour (ACH), air quality index, heating setpoint, cooling setpoint, time temperature within range, comfort score, and/or other kinds of data. For a sensor and a flow meter, the predetermined point kind dataset may include building pressure, building pressure setpoint, and/or other types of data.

The third dataset may define more, less, and/or different data. For example, for each type of data defined within the third dataset, the third dataset may also define a device that hosts the respective type of data. As discussed further below, the employee, for example, may select from device designators generated by the processor.

The plurality of datasets may include more, fewer, and/or different datasets. For example, the employee of the enterprise may also define data (e.g., within cells) of a fourth dataset of the plurality of datasets (e.g., a fourth sheet of the plurality of sheets) using one or more input devices (e.g., the mouse and the keyboard) at the computing device of the building control system, for example. The fourth dataset defines location groups, including locations defined by the first dataset, controlled by the building control system. Such location groups may be associated with roles within the enterprise (e.g., a nurse). As shown in the example below in Table 4, the fourth dataset may define location group names and a location group type for each of the location group names.

TABLE 4

| LocationGroupType | LocationGroupName |
|---|---|
| NurseStation | 2477 Nurse Station |
| Pharmacy | 2477 Pharmacy |
| NurseStation | 2450 Nurse Station |
| MeetingRoom | 2477 Surgeon |

The employee may select the location group type from a predetermined group of location group types. For example, for an enterprise that is a hospital, the predetermined group of location group types may include meeting room, nurse station, pharmacy, and/or other location group types.

Referring to Table 1 above, at least some of the locations (e.g., each location that includes a floor and/or a room) defined within the first dataset (e.g., at least some subsets of data of the first dataset) may be associated with (e.g., include within the respective subset of data of the first dataset) location group names, respectively. The employee, for example, may select a location group name, as defined in the fourth dataset, for any number of locations defined within the first dataset (e.g., within rows of the first sheet). The first dataset may be linked to the fourth dataset via the selected location group names.

As another example, the employee of the enterprise may also define data (e.g., within cells) of a fifth dataset of the plurality of datasets (e.g., a fifth sheet of the plurality of sheets) using one or more input devices (e.g., the mouse and the keyboard) at the computing device of the building control system, for example. The fifth dataset defines devices (e.g., controlled by the building control system) that control the equipment defined in the second dataset. As shown in the example below in Table 5, the fifth dataset may define, for each device within the building control system, a device name and a network name.

TABLE 5

| DeviceName | NetworkName | DeviceDesignator |
|---|---|---|
| MY_A01_PXCM | CXR | Network: CXR_Device: MY_A01_PXCM |
| CR_A03_PXCM | CXR | Network: CXR_Device: CR_A03_PXCM |
| MY_A04_PXCM | CXR | Network: CXR_Device: MY_A04_PXCM |
| MY_A05_PXCM | ATX | Network: ATX_Device: MY_A05_PXCM |
| MY_A06_PXCM | ATX | Network: ATX_Device: MY_A06_PXCM |

In the example shown, device names for each of the devices of the building control system may be defined by the employee of the enterprise or may be imported from another source. For example, the device names may be maintained within another dataset (e.g., as the devices are brought online within the building control system), and the device names may be imported from the other dataset.

The fifth dataset may also define a network name for each of the devices (e.g., device names) defined by the fifth dataset (e.g., within a respective row of the fifth sheet). The network names may correspond to computer networks operated within the locations of the enterprise and via which the devices are connected (e.g., in communication).

A processor (e.g., the processor 110 of the building control system) generates a device designator for each of the devices defined within the fifth dataset based on data within the respective subset of the fifth dataset (e.g., each row of the fifth sheet or dataset). For example, the processor may generate a device designator that includes data identifying the device name and the network name. For example, referring to the example of Table 5, the processor may generate a device designator for the first identified device (e.g., corresponding to row one) of “Network:CXR_Device:My_A01_PXCM.” The processor may generate device designators in different ways including different information.

Referring to Table 2 above, at least some of the equipment defined within the second dataset (e.g., at least some subsets of data of the second dataset) may be associated with (e.g., include within the respective subset of data of the second dataset) the devices defined in the fifth dataset, respectively. The employee, for example, may select a device designator, as defined in the fifth dataset, for any number of pieces of equipment defined within the second dataset (e.g., within rows of the second sheet). The second dataset may be linked to the fifth dataset via the selected device designators.

Referring to Table 3 above, at least some of the types of data defined within the third dataset (e.g., at least some subsets of data of the third dataset) may be associated with (e.g., include within the respective subset of data of the third dataset) the devices defined in the fifth dataset, respectively. For example, the third dataset may define devices of the fifth dataset on which the different types of data are hosted, respectively. The employee, for example, may select a device designator, as defined in the fifth dataset, for any number of the different types of data defined within the third dataset (e.g., within rows of the third sheet). The third dataset may be linked to the fifth dataset via the selected device designators.

The linking of the plurality of datasets allows time series data generated by the building control system, and corresponding UI templates for displaying the time series data, to be identified based on defined location groups and employee roles at the enterprise associated with the defined location groups. For example, an employee with a role of nurse may be associated with a particular nurse station (e.g., “2477 Nurse Station”), and a processor (e.g., the process of the Clous) may traverse the plurality of linked datasets to identify a subset of the different types of data defined in the third dataset for display for the nurse associated with the particular nurse station at the enterprise.

A UI (e.g., a graphical user interface (GUI)) displayed at the display 140 of the workstation may be automatically configured for a user of the workstation, such that information relevant to the user is displayed to the user without time-consuming customization of the UI being necessary. The database 152 of the server 150 stores a plurality of UI templates, via which a user may view and/or control a parameter within one or more buildings controlled by the building management system 160.

Each UI template of the plurality of UI templates is linked to at least one type of data (e.g., at least one parameter controlled by the building management system 160) and may be any number of different shapes and/or sizes. For example, a first UI template of the plurality of UI templates may be a UI panel of a first predetermined size (e.g., two inches by two inches square) that is linked to and displays a temperature within a first room of a first building of an enterprise. A second UI template of the plurality of UI templates may be a UI panel of the first predetermined size that is linked to and displays a temperature within a second room of the first building of the enterprise. A third UI template of the plurality of UI templates may be a UI panel of the first predetermined size that is linked to and displays a temperature within a first room of a second building of the enterprise. A fourth UI template of the plurality of UI templates may be a UI panel of a second predetermined size (e.g., four inches by two inches rectangle) that is linked to and displays a fan speed for a fan associated with the first room of the first building.

Any template may be linked to and display multiple parameters, such as temperatures and/or fan speeds for one or multiple rooms. Any building automation parameters may be available, depending on the role or job of the user. Some example parameters include temperature, fan speed, humidity, flow, pressure, status, and/or setpoints thereof.

The plurality of UI templates stored at the database 152 may include more, fewer, and/or different UI templates. For example, the plurality of UI templates may include UI templates for the display and control of fan speed, valve opening, pressure, other parameters, or any combination thereof.

The building management system 160 may receive time series data (e.g., of different data types corresponding to parameters within the one or more buildings) indicating the operation of the various components of the building automation system 170. The building management system 160 may forward the received time series data indicating the operation of the various components of the building automation system 170 to the server 150, and the time series data may be stored in the database 152 of the server 150. A processor (e.g., the processor 110 or a processor of the server 150) may process (e.g., semantically enhance or tag) the time series data, such that the time series data may be linked to the plurality of UI templates, respectively. For example, the processor may identify a first datapoint of the time series data as being a measured temperature within the first room of the first building and tag the first datapoint as such. The first UI template may thus be linked with the first datapoint (e.g., and any other datapoints of the time series data identified as being a measured temperature within the first room of the first building).

The user may request display of the UI at the workstation (e.g., by logging into a web interface at the workstation). The processor of the server 150 determines a source of the request. When generating the request, the workstation, for example, may include requestor identification information within the request. Alternatively, the first computing device workstation, for example, may transmit the requestor identification information to the server 150 separately from the request. In one embodiment, the user, for example, enters login data (e.g., a username and a password) to display the UI, and the workstation, for example, transmits at least some of the login data to the server 150, such that the server 150 may determine the source of the request based on the login data. The server 150 may identify the source of the request in other ways.

The processor of the server 150 may compare the determined source of the request to authorization data stored at the database 152, for example. The authorization data may identify users of the enterprise that are authorized to interact with the building management system 160, for example. In other words, the server 150 determines whether the source of the request (e.g., the user) is authorized to view and/or control parameters of the one or more buildings, controlled by the building management system 160. Based on the comparison, the server 104 may determine whether the determined source of the request matches the authorization data.

The server 150 may receive the user identification data and may determine a role and/or a location group name associated with the user based on the received user identification data. For example, the server 150 may store a role associated with the user and may identify the role for the user based on the user identification data. The server 150 may also store one or more location group names associated with each role defined for the enterprise. The server 150 may then identify one or more location group names associated with the user based on the identified role for the user.

The server 150 identifies a subset of UI templates of the plurality of UI templates that correspond to, for example, the subset of the different types of data identified by the processor traversing the plurality of linked datasets for the one or more location group names associated with the user. For example, for a first user, the server 150 may identify that the first UI template and the second UI template are to be displayed to the first user upon login.

The server 150 may transmit data for the identified subset of UI templates to the workstation, and the workstation may process the transmitted data and display the identified subset of UI templates to the user as the UI at the display. In one embodiment, the plurality of UI templates are stored locally at the workstation, and the server 150 transmits data identifying the subset of UI templates. The workstation may then generate the UI including the subset of UI templates stored at the workstation.

The server 150 may also transmit the linked datapoints of the time series data, such that the UI displays the linked datapoints within the subset of UI templates of the UI, respectively. In one embodiment, the linked datapoints of the time series data are stored locally at the workstation, and the UI displays the locally stored linked datapoints within the subset of UI templates.

The user may control parameters at one or more buildings of the enterprise using the displayed subset of UI templates. For example, the user may control the temperature within the first room of the first building within the first UI template displayed within the UI, and may control the temperature within the second room of the first building within the second UI template displayed within the UI.

The enterprise may be any number of different enterprises including, for example, a hospital or a school. The enterprise may include employees with particular roles at the enterprise (e.g., roles specific to a function of the enterprise). For example, the hospital may include nurses, doctors, custodians, and/or other employees with other roles at the enterprise. As another example, the school may include teachers, principals, coaches, custodians, and/or other employees with other roles at the enterprise. The enterprise may also include one or more engineering technicians.

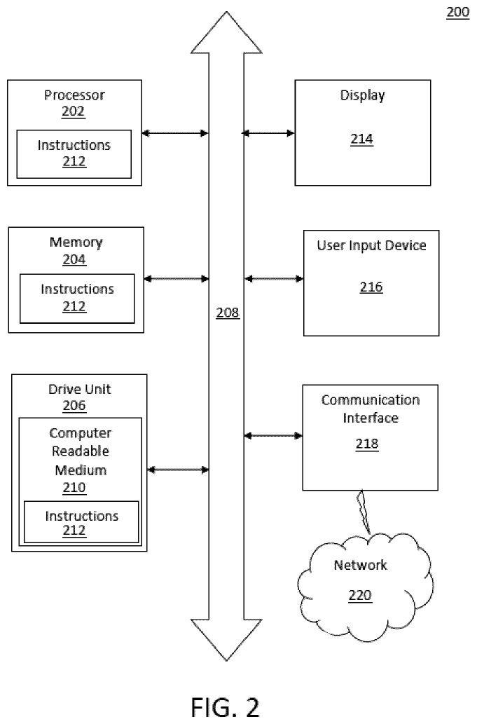

FIG. 2 shows an illustrative embodiment of a general computer system 200. The computer system 200 may include a set of instructions that may be executed to cause the computer system 200 to perform any one or more of the methods or computer-based functions disclosed herein. The computer system 200 may operate as a standalone device or may be connected (e.g., using a network) to other computer systems or peripheral devices. Any of the components discussed above (e.g., the building control system, the building automation system 170, or the building management system 160) may be a computer system 200 or a component in the computer system 200.

In a networked deployment, the computer system 200 may operate in the capacity of a server or as a client user computer in a client-server user network environment, or as a peer computer system in a peer-to-peer (or distributed) network environment. The computer system 200 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In one embodiment, the computer system 200 may be implemented using electronic devices that provide voice, video or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 2, the computer system 200 may include a processor 202, e.g., a central processing unit (CPU), a graphics processing unit (GPU), or both. The processor 202 may be a component in a variety of systems. For example, the processor 202 may be part of a standard personal computer or a workstation. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The computer system 200 may include a memory 204 that may communicate via a bus 208. The memory 204 may be representative of the database 152. The memory 204 may be a main memory, a static memory, or a dynamic memory. The memory 204 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 204 includes a cache or random access memory for the processor 202. In alternative embodiments, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the programmed processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 200 may further include a display unit 214, such as a liquid crystal display (LCD), an organic light emitting diode (OLED), a flat panel display, a solid-state display, a cathode ray tube (CRT), a projector, a printer or other now known or later developed display device for outputting determined information. The display 214 may act as an interface for the user to see the functioning of the processor 202, or specifically as an interface with the software stored in the memory 204 or in a disk or optical drive unit 206 (e.g., a disk drive unit).

Additionally, the computer system 200 may include an input device 216 configured to allow a user to interact with any of the components of system 200. The input device 216 may be a number pad, a keyboard, or a cursor control device, such as a mouse, or a joystick, touch screen display, remote control or any other device operative to interact with the system 200.

In one embodiment, as depicted in FIG. 2, the computer system 200 may also include the disk or optical drive unit 206. The disk drive unit 206 may include a computer-readable medium 210, in which one or more sets of instructions 212 (e.g.) software) may be embedded. Further, the instructions 212 may embody one or more of the methods or logic as described herein. In one embodiment, the instructions 212 may reside completely, or at least partially, within the memory 204 and/or within the processor 202 during execution by the computer system 200. The memory 204 and the processor 202 also may include computer-readable media as discussed above.

The present disclosure contemplates a non-transitory computer-readable medium that includes instructions 212 or receives and executes instructions 212 responsive to a propagated signal, so that a device connected to a network 220 may communicate voice, video, audio, images or any other data over the network 220. Further, the instructions 212 may be transmitted or received over the network 220 via a communication port 218. The communication port 218 may be a part of the processor 202 or may be a separate component. The communication port 218 may be created in software or may be a physical connection in hardware. The communication port 218 is configured to connect with the network 220 or another network, external media, the display 214, any other components in system 200, or combinations thereof. The connection with the network 220 may be a physical connection, such as a wired Ethernet connection or may be established wirelessly as discussed below. Likewise, the additional connections with other components of the system 200 may be physical connections or may be established wirelessly.

The network 220 may include wired networks, wireless networks, or combinations thereof, and may be representative of the network 106. The wireless network may be a cellular telephone network, an 802.11, 802.16, 802.20, or WiMax network. Further, the network 220 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media (e.g., a centralized or distributed database and/or associated caches and servers that store one or more sets of instructions). The term “computer-readable medium” shall also include any medium that is capable of storing, encoding or carrying a set of instructions for execution by a processor or that cause a computer system to perform any one or more of the methods or operations disclosed herein.

In a particular non-limiting, example embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In one embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an example, non-limiting embodiment, implementations may include distributed processing, component/object distributed processing, and parallel processing. Alternatively, virtual computer system processing may be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

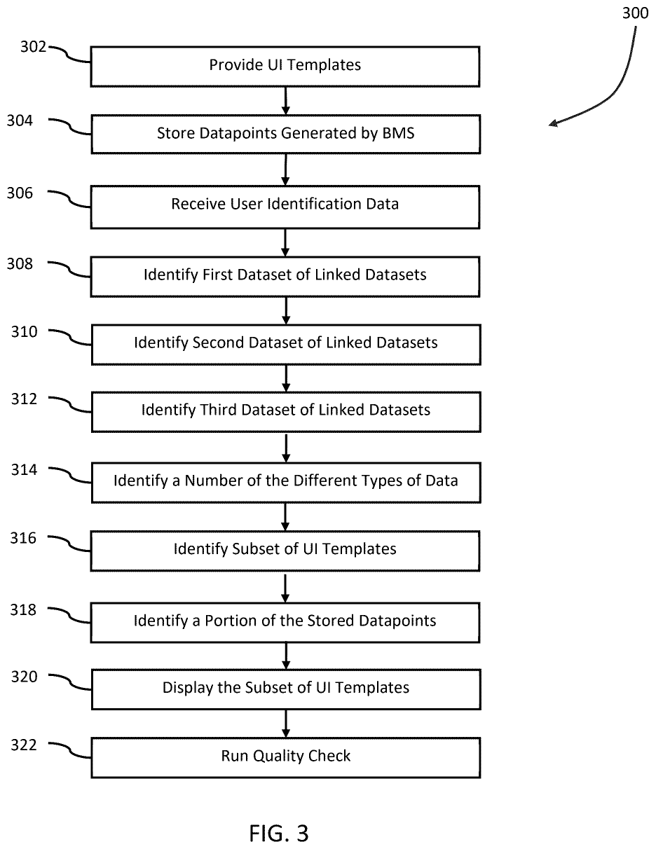

FIG. 3 shows a flowchart of one embodiment of a method 300 for automatically configuring a UI for a user of a building management system. The method 300 may be performed using the system 100 shown in FIG. 1, one or more of the computer systems 200 shown in FIG. 2, or another system. The method 300 is implemented in the order shown, but other orders may be used. Additional, different, or fewer acts may be provided. Similar methods may be used for presenting information relevant to user activity.

In act 302, a plurality of UI templates are provided. The plurality of UI templates may be provided in a database in communication with a building control system, a building automation system, and/or a building management system (e.g., a building control system). The building control system, for example, includes a plurality of workstations within one or more buildings of an enterprise, and the building control system controls controllers and/or equipment within the one or more buildings of the enterprise. A user of a plurality of users (e.g., employees) within the enterprise interacts with a workstation of the plurality of workstations to view data related to the controllers and/or the equipment, and/or to control parameters associated with the controllers and/or the equipment.

In one embodiment, the database is a database of a server remote from the building control system. For example, the server is a Cloud server. In another embodiment, the database is a database of the building control system (e.g., stored within a memory of one or more workstations of the plurality of workstations).

In act 304, a memory stores a plurality of datapoints generated by the building management system. The plurality of datapoints may be time series data for parameters associated with the controllers and/or equipment within the one or more buildings. For example, a first subset of datapoints of the plurality of datapoints may be time series data for a temperature measured by a first sensor within a first room of a first building of the one or more buildings. A second subset of datapoints of the plurality of datapoints may be time series data for a temperature measured by a second sensor within a second room of the first building. A third subset of datapoints of the plurality of datapoints may be time series data for a temperature measured by a third sensor within a first room of a second building of the one or more buildings. A fourth subset of datapoints of the plurality of datapoints may be time series data for a fan speed measured by a fourth sensor of a fan associated with the first room of the first building. The plurality of datapoints may include more, fewer, and/or different types of data associated with more, fewer, and/or different controllers and/or equipment of the one or more buildings.

The memory may be a memory of the remote server. For example, the controllers and/or the equipment of the building management system may generate the plurality of datapoints and transmit, via a network, the plurality of datapoints to the memory of the remote server for storage. In one embodiment, the memory is a memory of the building management system (e.g., a workstation of the plurality of workstations).

In act 306, a first processor receives user identification data for the user. For example, the user enters the identification data at the workstation, via one or more input devices of the workstation (e.g., a keyboard). The identification data may be any number of different types of user identification data including, for example, a username and/or a password. The first processor may be, for example, a processor of the workstation.

The first processor transmits (e.g., via the network) the received user identification data to, for example, the remote server (e.g., a second processor). For example, the first processor may transmit the received username and password to the remote server to determine whether the user is an authorized user (e.g., is permitted to interact with the building management system) and/or to determine a UI to be automatically generated and displayed at the workstation.

In act 308, the first processor or the second processor (e.g., remote from the first processor) identifies a first dataset of a plurality of linked datasets stored by the memory or another memory (e.g., the memory). The first dataset identifies at least one location for the enterprise. For example, for each location of the at least one location for the enterprise, the first dataset defines a location group, a building, a floor within the building, and a room on the floor. An employee of the enterprise or someone outside of the enterprise (e.g., an engineer outside of the enterprise) may generate the first dataset and transmit the first dataset to the second processor, for example. The second processor, for example, may generate a location identifier (e.g., a first identifier) for each location of the at least one location for the enterprise based on the respective building, the respective floor, and the respective room.

In act 310, the second processor, for example, identifies a second dataset of the plurality of linked datasets. The second dataset identifies at least one piece of equipment operated at the at least one location, respectively, and controlled by the building control system. For example, for each piece of equipment of the at least one piece of equipment, the second dataset defines a type of equipment, an instance of the type of equipment, and a location of the at least one location for the respective piece of equipment. An employee of the enterprise or someone outside of the enterprise (e.g., an engineer outside of the enterprise) may generate the second dataset and transmit the second dataset to the second processor, for example. Generating the second dataset may include selecting the location for the respective piece of equipment from the generated first identifiers, such that the second dataset is linked to the first dataset

The second processor, for example, may generate an equipment identifier (e.g., a second identifier) for each piece of equipment of the at least one piece of equipment based on the type of equipment and the instance of the type of equipment.

In act 312, the second processor, for example, identifies a third dataset of the plurality of linked datasets. The third dataset identifies at least one type of data of the different types of data used by the at least one piece of equipment, respectively. For example, for each of the different types of data generated by devices of the building control system, the third dataset defines a name, equipment of the at least one piece of equipment that uses the respective type of data, and a parameter associated with the respective type of data (e.g., a kind of data). An employee of the enterprise or someone outside of the enterprise (e.g., an engineer outside of the enterprise) may generate the third dataset and transmit the third dataset to the second processor, for example. Generating the third dataset may include selecting the equipment that uses the respective type of data from the generated second identifiers, such that the third dataset is linked to the second dataset.

The second processor, for example, may identify more, fewer, and/or different types of data. For example, the second processor identifies a fourth dataset of the plurality of linked datasets. The fourth dataset identifies location groups. Generating the first dataset may include selecting a location group of the location groups defined by the fourth dataset for each of the locations defined within the first dataset, such that the first dataset is linked to the fourth dataset.

As another example, the second processor identifies a fifth dataset of the plurality of linked datasets. The fifth dataset identifies the devices that generate the different types of data. For example, the fifth dataset defines, for each of the devices, a device name and a network name. The second processor, for example, may generate a device identifier (e.g., a third identifier) for each of the devices based on the respective device name and the respective network name.

In one embodiment, generating the second dataset may include selecting the respective device that the respective piece of equipment from the generated third identifiers, such that the second dataset is also linked to the fifth dataset.

In one embodiment, generating the third dataset may include selecting the respective device that hosts the respective type of data from the generated third identifiers, such that the third dataset is also linked to the fifth dataset.

In act 314, the second processor identifies a number of the different types of data based on the user identification data and at least the first dataset identified in act 308, the second dataset identified in act 310, and the third dataset identified in act 312.

In one embodiment, the second processor, for example, identifies a role associated with the user based on the user identification data for the user. For example, the second processor is a processor of the remote server, and the second processor identifies the role associated with the user based on the user identification data for the user received at the workstation and transmitted to the remote server.

The remote server may store data for roles for a plurality of users (e.g., employees of the enterprise), respectively. The remote server, for example, may identify a role for the user based on the received user identification data and this stored data. For example, the remote server may determine the user has a role of nurse. The remote server may also determine a location group corresponding to the user and/or the determined role for the user. For example, the remote server may also store data for location groups that correspond to different roles within the enterprise. For example, the role of nurse may correspond to (e.g., needs to view data for) a nurse station.

The second processor, for example, may traverse the plurality of linked datasets and determine the types of data to be displayed to the user (e.g., within the third dataset) based on one or more determined location groups. For example, the location group of “nurse stand” may be linked to locations of room 100 on floor 1 of building 1, and room 200 on floor 2 of building 1. The locations may be linked to an air handler and a sensor, respectively. The third dataset of the plurality of linked datasets may define types of data (e.g., humidity and temperature) associated with the identified air handler and the identified sensor, respectively.

In act 316, the second processor, for example, identifies a subset of UI templates of the plurality of UI templates stored in the database based on the number of different types of data identified in act 314. Using the example above, the second processor, for example, may identify UI templates of the plurality of UI templates that correspond to humidity for the air handler of room 100 on floor 1 of building 1 and temperature for the sensor of room 200 on floor 2 of building 1, respectively.

In act 318, the second processor, for example, identifies a portion of the time series data stored in act 304, based on the number of different types of data identified in act 314. In act 320, the subset of UI templates identified in act 310 are displayed as the UI at the workstation. Datapoints of the plurality of datapoints linked to the subset of UI templates identified in act 318 may also be displayed with the subset of UI templates, respectively. In one embodiment, the user may control at least some of the equipment defined within the second dataset via the subset of UI templates displayed as the UI in act 320.

In act 322, the second processor, for example, may run a quality check (e.g. using a semantic enhancement engine). The quality check may provide a total of expected equipment versus realized equipment and/or may provide a quality check score. The quality check score may identify whether a number of actual data points and/or relationships checked (e.g., as defined by the plurality of linked datasets) match an expected number of data points and/or relationships, respectively.

For example, the second processor traverses the linked datasets (e.g., the first dataset, the second dataset, the third dataset, the fourth dataset, and the fifth dataset) and identifies expected relationships or links (e.g., expected links), a number of such expected links, and a number of expected completed subsets (e.g., rows) within each dataset of the plurality of linked datasets. For example, a relationship or link may be expected for each piece of equipment defined in the second dataset to a location defined in the first dataset. As another example, a relationship or link may be expected for each type of data defined in the third dataset to a piece of equipment defined in the second dataset.

The second processor, for example, also identifies actual relationships or links (e.g., actual links), a number of such actual links, and number of actual completed subsets (e.g., rows) within the plurality of linked datasets. The second processor, for example, may compare the actual links to expected links to identify missing data within the plurality of linked datasets. The second processor, for example, may also compare the number of actual links to the number of expected links to identify an amount of missing data. Such comparisons may identify when pieces of equipment defined within the second dataset, for example, are not linked to locations defined within the first dataset, types of data defined within the third dataset, and/or equipment defined within the fifth dataset. The second processor, for example, may also calculate a percentage score based on the number of expected links and the number of actual links and/or based on the number of expected completed subsets and the actual number of completed subsets.

In one embodiment, the second processor (e.g. using the semantic enhancement engine), for example, may also identify types of data (e.g., as defined within the third dataset) that are not properly tagged (e.g., for linking to the UI templates).

The second processor may output quality check data and transmit the quality check data to the first processor (e.g., the workstation of the building management system) for display at, for example, the workstation. The user at the workstation, for example, may use the quality check data to identify information that still needs to be added to the plurality of linked datasets to model the building management system.

An example of such output quality check data is provided below:

{

“QualityUser.Device.ControlsEquipment.Actual”: 367,
“QualityUser.Device.ControlsEquipment.Expected”: 367,
“QualityUser.Device.ControlsEquipment.Missing”: 0,
“QualityUser.Equipment.ConcernsLocation.Actual”: 367,
“QualityUser.Equipment.ConcernsLocation.Expected”: 367,
“QualityUser.Equipment.ConcernsLocation.Missing”: 0,
“QualityUser.Equipment.Total.Actual”: 367,
“QualityUser.Equipment.Total.Expected”: 367,
“QualityUser.Equipment.Total.Missing”: 0,
“QualityUser.Equipment.btas:VAVBox.Actual”: 336,
“QualityUser.Equipment.btas:VAVBox.Expected”: 336,
“QualityUser.Equipment.btas:VAVBox.Missing”: 0,
“QualityUser.Equipment.seas:PressureMonitor.Actual”: 31,
“QualityUser.Equipment.seas:PressureMonitor.Expected”: 31,
“QualityUser.Equipment.seas:PressureMonitor.Missing”: 0,
“QualityUser.Location.HasEquipment.Actual”: 351,
“QualityUser.Location.HasEquipment.Expected”: 351,
“QualityUser.Location.HasEquipment.Missing”: 0,
“QualityUser.Location.HasUsageType.Actual”: 339,
“QualityUser.Location.HasUsageType.Expected”: 339,
“QualityUser.Location.HasUsageType.Missing”: 0,
“QualityUser.Location.Total.Actual”: 351,
“QualityUser.Location.Total.Expected”: 351,
“QualityUser.Location.Total.Missing”: 0,
“QualityUser.Location.btlo:Building.Actual”: 2,
“QualityUser.Location.btlo:Building.Expected”: 2,
“QualityUser.Location.btlo:Building.Missing”: 0,
“QualityUser.Location.btlo:Floor.Actual”: 10,
“QualityUser.Location.btlo:Floor.Expected”: 10,
“QualityUser.Location.btlo:Floor.Missing”: 0,
“QualityUser.Location.btlo:Room.Actual”: 339,
“QualityUser.Location.btlo:Room.Expected”: 339,
“QualityUser.Location.btlo:Room.Missing”: 0,
“QualityUser.Point.HasTags.Actual”: 934,
“QualityUser.Point.HasTags.Expected”: 934,
“QualityUser.Point.HasTags.Missing”: 0,
“QualityUser.Point.UsedByEquipment.Actual”: 934,
“QualityUser.Point.UsedByEquipment.Expected”: 934,
“QualityUser.Point.UsedByEquipment.Missing”: 0

}

The example quality check data provided above does not identify any missing information. Every metric includes “Actual,” “Expected,” and “Missing” values, respectively. The “Expected” value is equal to the “Actual” value plus the “Missing” value. The second processor, for example, may calculate a percentage of missing entries by dividing the “Missing” value by the “Actual” value. Additional, less, and/or different quality check data may be provided.

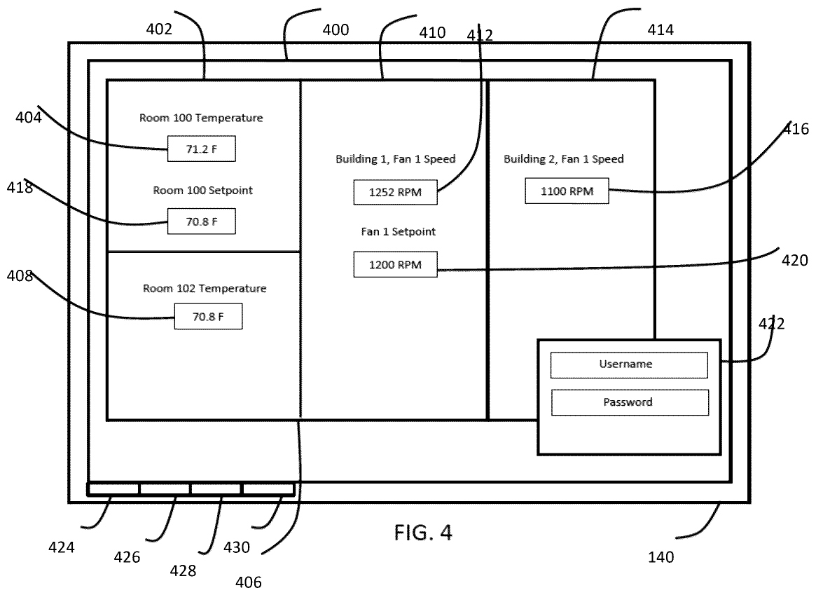

FIG. 4 shows an example of a UI 400 that may be automatically generated for a particular user by the method 300 of FIG. 3 or another method. The UI 400 may be displayed at, for example, the display 140 of the building control system of FIG. 1 or another computing device. The UI 400 may include one or more windows or panels (e.g., panels). For example, the UI 400 includes a first panel 402 (e.g., corresponding to the first UI template) that displays a representation of a first type of data 404. The representation of the first type of data 404 may include one or more linked datapoints corresponding to the first type of data. For example, the one or more linked datapoints may include at least one datapoint of time series data for the first type of data. In other words, the representation of the first type of data 404 may include a most recently measured value of the first type of data. The displayed representation of the first type of data 404 may change when a new value for the second type of data is measured.

The first type of data may be any number of different types of data. For example, the first type of data may be a temperature within a first room of a first building (e.g., Room 100). In other embodiments, the first panel 402 may display additional and/or different types of data (e.g., pressure within Room 100). The representation of the first type of data 404 may include a most recently measured temperature within Room 100, for example.

In the embodiment shown, the UI 400 also includes a second panel 406 (e.g., corresponding to the second UI template) that displays a representation of a second type of data 408. The representation of the second type of data 408 may include one or more linked datapoints corresponding to the second type of data. For example, the one or more linked datapoints may include at least one datapoint of time series data for the second type of data. In other words, the representation of the second type of data 408 may include a most recently measured value of the second type of data. The displayed representation of the second type of data 408 may change when a new value for the second type of data is measured.

The second type of data may be any number of different types of data. For example, the second type of data may be a temperature within a second room of the first building (e.g., Room 102). In other embodiments, the second panel 406 may display additional and/or different types of data (e.g., pressure within Room 102). The representation of the second type of data 408 may include a most recently measured temperature within Room 102, for example.

In the embodiment shown, the UI 400 also includes a third panel 410 (e.g., corresponding to the fourth UI template) that displays a representation of a third type of data 412. The representation of the third type of data 412 may include one or more linked datapoints corresponding to the third type of data. For example, the one or more linked datapoints may include at least one datapoint of time series data for the third type of data. In other words, the representation of the third type of data 412 may include a most recently measured value of the third type of data. The displayed representation of the third type of data 412 may change when a new value for the third type of data is measured.

The third type of data may be any number of different types of data. For example, the third type of data may be a fan speed for a fan within the first building (e.g., Room 100). In other embodiments, the third panel 410 may display additional and/or different types of data (e.g., humidity within the first building). The representation of the third type of data 412 may include a most recently measured fan speed of the fan within the first building, for example.

In the embodiment shown, the UI 400 also includes a fourth panel 414 (e.g., corresponding to a fifth UI template of the plurality of UI templates) that displays a representation of a fourth type of data 416. The representation of the fourth type of data 416 may include one or more linked datapoints corresponding to the fourth type of data. For example, the one or more linked datapoints may include at least one datapoint of time series data for the fourth type of data. In other words, the representation of the fourth type of data 416 may include a most recently measured value of the fourth type of data. The displayed representation of the fourth type of data 416 may change when a new value for the third type of data is measured.

The fourth type of data may be any number of different types of data. For example, the fourth type of data may be a fan speed for a fan within a second building. In other embodiments, the fourth panel 414 may display additional and/or different types of data (e.g., humidity within the second building). The representation of the fourth type of data 416 may include a most recently measured fan speed of the fan within the second building, for example.

The UI 400 may also include a login window 422 in which identification information (e.g., a username and/or a password) may be entered by, for example, the user with one or more input devices (e.g., a mouse and a keyboard) at the workstation. The UI 400 may include more, fewer, and/or different windows, tabs, buttons, and/or other interfaces.

For example, the UI 400 may include a number of tabs corresponding to a number of different pages within the UI 400, respectively. In the example of FIG. 4, a page corresponding to a first tab 424 is shown. The first tab 424 may correspond to the automatically generated UI (e.g., “My Dashboard”; generated with the method 300 of FIG. 3 or another method). A second tab 426 may correspond to insights for the automatically generated UI shown at the first tab 424. For example, information about controllers and/or equipment that is monitored and/or controlled at the first tab 424 may be displayed within the second tab 426. A third tab 428 may correspond to building insights. For example, information about buildings within which the controllers and/or the equipment that is monitored and/or controlled is located may be displayed within the third tab 428. A fourth tab 430 may include recommendations for additional UI templates to be displayed. For example, when a predetermined number of users with a particular role or a predetermined percentage of users with a particular role add a UI template (e.g., a frequently added UI template) to be displayed (e.g., at the first tab 424), the frequently added UI template may be pushed to all users with the particular role. The fourth tab 430 may identify and/or show such frequently requested UI templates. Additional, fewer, and/or different tabs may be presented to the user within the UI 400.

The user may add UI templates (e.g., panels) to or remove UI templates from the automatically generated UI 400 shown in FIG. 4. For example, the user may add UI templates (e.g., the third UI template) defined as available to the user (e.g., defined as addable). The user may interface with the automatically generated UI 400 to move and/or size the panels (e.g., the first panel 402, the second panel 406, the third panel 410, and/or the fourth panel 414) within the UI 400. Such positioning and/or sizing customization may be saved (e.g., locally at the workstation) and applied the next time the user logs in to access the UI 400.

Illustrative Embodiment 1. A method for displaying a user interface (UI) with information related to equipment within one or more buildings of an enterprise, the method comprising: providing time series data generated by devices of a building management system, the time series data representing different types of data generated by the devices, respectively; identifying a first dataset, the first dataset identifying at least one location for the enterprise; identifying a second dataset, the second dataset identifying at least one piece of equipment operated at the at least one location, respectively, and controlled by the building management system; and identifying a third dataset, the third dataset identifying at least one type of data of the different types of data used by the at least one piece of equipment, respectively, wherein the first dataset, the second dataset, and the third dataset are linked; receiving a request for a portion of the time series data, the portion of the time series data corresponding to a location of the at least one location identified within the first dataset; identifying, by a processor, the portion of the time series data based on the received request, the received first dataset, the received second dataset, and the received third dataset, the identifying of the portion of the time series data comprising traversing, by the processor, the linked first dataset, second dataset, and third dataset based on the location, such that a piece of equipment of the at least one piece of equipment of the second dataset and a type of data of the different types of data of the third dataset are identified; and generating and displaying the UI, which is configured using the portion of the time series data, the portion of the time series data including the identified type of data for the identified piece of equipment.

Illustrative Embodiment 2. The method of Illustrative Embodiment 1, further comprising controlling, via the building management system, the piece of equipment based on input received at the UI.

Illustrative Embodiment 3. The method of any of Illustrative Embodiments 1-2, wherein the first dataset defines, for each location of the at least one location for the enterprise, a location group, a building, a floor within the building, and a room on the floor.

Illustrative Embodiment 4. The method of any of Illustrative Embodiments 1-3, wherein the second dataset defines, for each piece of equipment of the at least one piece of equipment, a type of equipment, an instance of the type of equipment, and a location of the at least one location for the respective piece of equipment.

Illustrative Embodiment 5. The method of any of Illustrative Embodiments 1-4, wherein the third dataset defines, for each of the different types of data generated by the devices, a name, equipment of the at least one piece of equipment that uses the respective type of data, and a parameter associated with the respective type of data.

Illustrative Embodiment 6. The method of any of Illustrative Embodiments 1-5, further comprising: generating a first identifier for each location of the at least one location for the enterprise based on the respective building, the respective floor, and the respective room; and generating a second identifier for each piece of equipment of the at least one piece of equipment based on the type of equipment and the instance of the type of equipment.

Illustrative Embodiment 7. The method of any of Illustrative Embodiments 1-6, wherein identifying the second dataset comprises generating the second dataset based on first user input, the generating of the second dataset based on the first user input comprising selecting, based on the first user input, the location for the respective piece of equipment from the generated first identifiers, such that the second dataset is linked to the first dataset, and wherein identifying the third dataset comprises generating the third dataset based on second user input, the generating of the third dataset based on the second user input comprising selecting, based on the second user input, the equipment that uses the respective type of data from the generated second identifiers, such that the third dataset is linked to the second dataset.

Illustrative Embodiment 8. The method of any of Illustrative Embodiments 1-7, further comprising: determining a number of expected links between the second dataset and the first dataset, the expected links being between each piece of equipment of the at least one piece of equipment and a respective location of the at least one location of the enterprise; determining a number of actual links between the second dataset and the first dataset, the actual links being between at least some pieces of equipment of the at least one piece of equipment and a respective location of the at least one location of the enterprise; and determining a quality check score based on the determined number of expected links and the determined number of actual links.

Illustrative Embodiment 9. The method of any of Illustrative Embodiments 1-8, further comprising receiving a fourth dataset, the fourth dataset identifying the location groups, wherein identifying the first dataset comprises generating the first dataset based on third user input, the generating of the first dataset based on the third user input comprising selecting, based on the third user input, the location group for the respective location from the location groups identified in the fourth dataset, such that the first dataset is linked to the fourth dataset.

Illustrative Embodiment 10. The method of any of Illustrative Embodiments 1-9, further comprising identifying a fifth dataset, the fifth dataset identifying the devices, wherein the fifth dataset defines, for each of the devices, a device name and a network name.

Illustrative Embodiment 11. The method of any of illustrative Embodiments 1-10, further comprising generating a third identifier for each of the devices based on the respective device name and the respective network name, wherein the generating of the third dataset is also based on fourth user input, the generating of the third dataset based on the fourth user input comprising selecting, based on the fourth user input, the respective device that hosts the respective type of data from the generated third identifiers, such that the third dataset is also linked to the fifth dataset.

Illustrative Embodiment 12. The method of any of illustrative Embodiments 1-11, further comprising: transmitting, by the building management system, the time series data to a cloud server; and storing, by a memory of the cloud server, the time series data, wherein the first dataset, the second dataset, and the third dataset are received by a processor of a computing device of the building management system, wherein receiving the request for the portion of the time series data comprises receiving, by a processor of the cloud server, the request for the portion of the time series data, and wherein displaying the UI comprises displaying the UI at a display of the computing device or a display of the other computing device of the building management system.

Illustrative Embodiment 13. The method of any of illustrative Embodiments 1-12, wherein receiving the request for the portion of the time series data further comprises receiving, by the processor of the other computing device, identification data for the user.

Illustrative Embodiment 14. The method of any of illustrative Embodiments 1-13, further comprising: transmitting the identification data for the user to the cloud server; and determining a role associated with the user based on the transmitted identification data.

Illustrative Embodiment 15. The method of any of illustrative Embodiments 1-14, wherein identifying the portion of the time series data comprises identifying a number of the different types of data corresponding to the determined role, based on the received first dataset, the received second dataset, and the received third dataset, and wherein generating and displaying the UI comprises: identifying a subset of UI templates from a plurality of UI templates stored at the memory of the cloud server based on the identified number of types of data; and transmitting the subset of UI templates to the other computing device of the building management system; and displaying the portion of the time series data within the subset of UI templates, respectively, as the UI at the display of the other computing device of the building management system.

Illustrative Embodiment 16. A system for displaying a user interface (UI) with information related to equipment within one or more buildings of an enterprise to a user of a building management system, the user having a role specific to a function of the enterprise, the system comprising: a database comprising: a plurality of UI templates, each UI template of the plurality of UI templates being linked to at least one type of data; and a plurality of datapoints generated by the building management system, each datapoint of the plurality of datapoints generated by the building management system corresponding to a respective one of the types of data and being linked to at least one UI template of the plurality of UI templates; a processor in communication with the database, the processor being configured to: identify a first dataset, the first dataset identifying at least one location for the enterprise; identify a second dataset, the second dataset identifying at least one piece of equipment operated at the at least one location, respectively, and controlled by the building management system; identify a third dataset, the third dataset identifying at least one type of data of the different types of data used by the at least one piece of equipment, respectively, the first dataset, the second dataset, and the third dataset being linked; receive a request for a portion of the time series data; identify a subset of datapoints of the plurality of datapoints based on the received request, the received first dataset, the received second dataset, and the received third dataset; and identify a subset of UI templates of the plurality of UI templates based on the identified subset of datapoints; and a display in communication with the processor, the display being configured to display the identified subset of datapoints within the subset of UI templates as the UI.

Illustrative Embodiment 17. The system of illustrative Embodiment 16, further comprising: a cloud server comprising a memory and the processor, the memory storing the database; and a computing device of the building management system in communication with the cloud server, the computing device comprising the display.

Illustrative Embodiment 18. The system of any of illustrative Embodiments 16-17, wherein the first dataset defines, for each location of the at least one location for the enterprise, a location group, a building, a floor within the building, and a room on the floor, wherein the second dataset defines, for each piece of equipment of the at least one piece of equipment, a type of equipment, an instance of the type of equipment, and a location of the at least one location for the respective piece of equipment, and wherein the third dataset defines, for each of the different types of data generated by the devices, a name, equipment of the at least one piece of equipment that uses the respective type of data, and a parameter associated with the respective type of data.

Illustrative Embodiment 19. A method for displaying a user interface (UI) to display information related to equipment within one or more buildings of an enterprise, the method comprising: providing time series data generated by devices of a building management system, the time series data representing different types of data generated by the devices, respectively; receiving a first dataset, the first dataset identifying at least one location for the enterprise; receiving a second dataset, the second dataset identifying at least one piece of equipment operated at the at least one location, respectively, and controlled by the building management system; receiving a third dataset, the third dataset identifying at least one type of data of the different types of data used by the at least one piece of equipment, respectively, wherein the first dataset, the second dataset, and the third dataset are linked; receiving, by a computing device of the building management system, identification data for a user of the computing device; transmitting the identification data for the user to a cloud server; identifying a number of the different types of data based on the transmitted identification data, the received first dataset, the received second dataset, and the received third dataset; identifying a portion of the time series data based on the identified number of different types of data; identifying a subset of UI templates from a plurality of UI templates stored at a memory of the cloud server based on the identified number of types of data; transmitting the identified subset of UI templates and the identified portion of the time series data to the computing device of the building management system; and displaying the identified portion of the time series data within the subset of UI templates as the UI at a display of the computing device of the building management system.

Illustrative Embodiment 20. The method of Illustrative Embodiment 19, further comprising controlling, via the computing device of the building management system, a piece of the equipment based on input received at the UI.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

1. A method for displaying a user interface (UI) with information related to equipment within one or more buildings of an enterprise, the method comprising:
providing time series data generated by devices of a building management system, the time series data representing different types of data generated by the devices, respectively;
identifying a first dataset, the first dataset identifying at least one location for the enterprise;
identifying a second dataset, the second dataset identifying at least one piece of equipment operated at the at least one location, respectively, and controlled by the building management system;
identifying a third dataset, the third dataset identifying at least one type of data of the different types of data used by the at least one piece of equipment, respectively, wherein the first dataset, the second dataset, and the third dataset are linked;
receiving a request for a portion of the time series data, the portion of the time series data corresponding to a location of the at least one location identified within the first dataset;
identifying, by a processor, the portion of the time series data based on the received request, the received first dataset, the received second dataset, and the received third dataset, the identifying of the portion of the time series data comprising traversing, by the processor, the linked first dataset, second dataset, and third dataset based on the location, such that a piece of equipment of the at least one piece of equipment of the second dataset and a type of data of the different types of data of the third dataset are identified; and
generating and displaying the UI, which is configured using the portion of the time series data, the portion of the time series data including the identified type of data for the identified piece of equipment.

2. The method of claim 1, further comprising controlling, via the building management system, the piece of equipment based on input received at the UI.

3. The method of claim 1, wherein the first dataset defines, for each location of the at least one location for the enterprise, a location group, a building, a floor within the building, and a room on the floor.

4. The method of claim 3, wherein the second dataset defines, for each piece of equipment of the at least one piece of equipment, a type of equipment, an instance of the type of equipment, and a location of the at least one location for the respective piece of equipment.

5. The method of claim 4, wherein the third dataset defines, for each of the different types of data generated by the devices, a name, equipment of the at least one piece of equipment that uses the respective type of data, and a parameter associated with the respective type of data.

6. The method of claim 5, further comprising:
generating a first identifier for each location of the at least one location for the enterprise based on the respective building, the respective floor, and the respective room; and
generating a second identifier for each piece of equipment of the at least one piece of equipment based on the type of equipment and the instance of the type of equipment.

7. The method of claim 6, wherein identifying the second dataset comprises generating the second dataset based on first user input, the generating of the second dataset based on the first user input comprising selecting, based on the first user input, the location for the respective piece of equipment from the generated first identifiers, such that the second dataset is linked to the first dataset, and wherein identifying the third dataset comprises generating the third dataset based on second user input, the generating of the third dataset based on the second user input comprising selecting, based on the second user input, the equipment that uses the respective type of data from the generated second identifiers, such that the third dataset is linked to the second dataset.

8. The method of claim 7, further comprising:
determining a number of expected links between the second dataset and the first dataset, the expected links being between each piece of equipment of the at least one piece of equipment and a respective location of the at least one location of the enterprise;
determining a number of actual links between the second dataset and the first dataset, the actual links being between at least some pieces of equipment of the at least one piece of equipment and a respective location of the at least one location of the enterprise; and
determining a quality check score based on the determined number of expected links and the determined number of actual links.

9. The method of claim 7, further comprising receiving a fourth dataset, the fourth dataset identifying the location groups,
wherein identifying the first dataset comprises generating the first dataset based on third user input, the generating of the first dataset based on the third user input comprising selecting, based on the third user input, the location group for the respective location from the location groups identified in the fourth dataset, such that the first dataset is linked to the fourth dataset.

10. The method of claim 9, further comprising identifying a fifth dataset, the fifth dataset identifying the devices,
wherein the fifth dataset defines, for each of the devices, a device name and a network name.

11. The method of claim 10, further comprising generating a third identifier for each of the devices based on the respective device name and the respective network name,
wherein the generating of the third dataset is also based on fourth user input, the generating of the third dataset based on the fourth user input comprising selecting, based on the fourth user input, the respective device that hosts the respective type of data from the generated third identifiers, such that the third dataset is also linked to the fifth dataset.

12. The method of claim 1, further comprising:
transmitting, by the building management system, the time series data to a cloud server; and
storing, by a memory of the cloud server, the time series data,
wherein the first dataset, the second dataset, and the third dataset are received by a processor of a computing device of the building management system,
wherein receiving the request for the portion of the time series data comprises receiving, by a processor of the cloud server, the request for the portion of the time series data, and
wherein displaying the UI comprises displaying the UI at a display of the computing device or a display of the other computing device of the building management system.

13. The method of claim 12, wherein receiving the request for the portion of the time series data further comprises receiving, by the processor of the other computing device, identification data for the user.

14. The method of claim 13, further comprising:
transmitting the identification data for the user to the cloud server; and
determining a role associated with the user based on the transmitted identification data.

15. The method of claim 13, wherein identifying the portion of the time series data comprises identifying a number of the different types of data corresponding to the determined role, based on the received first dataset, the received second dataset, and the received third dataset, and
wherein generating and displaying the UI comprises:
identifying a subset of UI templates from a plurality of UI templates stored at the memory of the cloud server based on the identified number of types of data;
transmitting the subset of UI templates to the other computing device of the building management system; and
displaying the portion of the time series data within the subset of UI templates, respectively, as the UI at the display of the other computing device of the building management system.

16. A system for displaying a user interface (UI) with information related to equipment within one or more buildings of an enterprise to a user of a building management system, the user having a role specific to a function of the enterprise, the system comprising:
a database comprising:
a plurality of UI templates, each UI template of the plurality of UI templates being linked to at least one type of data; and
a plurality of datapoints generated by the building management system, each datapoint of the plurality of datapoints generated by the building management system corresponding to a respective one of the types of data and being linked to at least one UI template of the plurality of UI templates;
a processor in communication with the database, the processor being configured to:
identify a first dataset, the first dataset identifying at least one location for the enterprise;
identify a second dataset, the second dataset identifying at least one piece of equipment operated at the at least one location, respectively, and controlled by the building management system;
identify a third dataset, the third dataset identifying at least one type of data of the different types of data used by the at least one piece of equipment, respectively, the first dataset, the second dataset, and the third dataset being linked;
receive a request for a portion of the time series data;
identify a subset of datapoints of the plurality of datapoints based on the received request, the received first dataset, the received second dataset, and the received third dataset; and
identify a subset of UI templates of the plurality of UI templates based on the identified subset of datapoints; and
a display in communication with the processor, the display being configured to display the identified subset of datapoints within the subset of UI templates as the UI.

17. The system of claim 16, further comprising:
a cloud server comprising a memory and the processor, the memory storing the database; and
a computing device of the building management system in communication with the cloud server, the computing device comprising the display.

18. The system of claim 16, wherein the first dataset defines, for each location of the at least one location for the enterprise, a location group, a building, a floor within the building, and a room on the floor,
wherein the second dataset defines, for each piece of equipment of the at least one piece of equipment, a type of equipment, an instance of the type of equipment, and a location of the at least one location for the respective piece of equipment, and
wherein the third dataset defines, for each of the different types of data generated by the devices, a name, equipment of the at least one piece of equipment that uses the respective type of data, and a parameter associated with the respective type of data.

19. A method for displaying a user interface (UI) to display information related to equipment within one or more buildings of an enterprise, the method comprising:
providing time series data generated by devices of a building management system, the time series data representing different types of data generated by the devices, respectively;
receiving a first dataset, the first dataset identifying at least one location for the enterprise;
receiving a second dataset, the second dataset identifying at least one piece of equipment operated at the at least one location, respectively, and controlled by the building management system;
receiving a third dataset, the third dataset identifying at least one type of data of the different types of data used by the at least one piece of equipment, respectively, wherein the first dataset, the second dataset, and the third dataset are linked;
receiving, by a computing device of the building management system, identification data for a user of the computing device;
transmitting the identification data for the user to a cloud server;
identifying a number of the different types of data based on the transmitted identification data, the received first dataset, the received second dataset, and the received third dataset;
identifying a portion of the time series data based on the identified number of different types of data;
identifying a subset of UI templates from a plurality of UI templates stored at a memory of the cloud server based on the identified number of types of data;
transmitting the identified subset of UI templates and the identified portion of the time series data to the computing device of the building management system; and
displaying the identified portion of the time series data within the subset of UI templates as the UI at a display of the computing device of the building management system.

20. The method of claim 19, further comprising controlling, via the computing device of the building management system, a piece of the equipment based on input received at the UI.
